(19) United States
(12) Patent Application Publication
(10) Pub. No.: US 2009/0228198 A1
(43) Pub. Date: Sep. 10, 2009

(54) SELECTING LANDMARKS IN SHORTEST PATH COMPUTATIONS

(75) Inventors: Andrew V. Goldberg, Redwood City, CA (US); Renato F. Werneck, Sunnyvale, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/043,975

(22) Filed: Mar. 7, 2008

(51) Int. Cl. G01C 21/20

(52) U.S. Cl. 701/201

(57) ABSTRACT

A set of landmarks may be selected during preprocessing by evaluating a sample of the queries that the landmarks may be used in. A cost function may be used to generate a k-median problem. The k-median problem may then be solved with heuristics. The landmarks may then be used with A* search to find the shortest path from a source to a destination.

### BACKGROUND

Existing computer programs known as “road-mapping” programs provide digital maps, often complete with detailed road networks down to the city-street level. Typically, a user can input a location and the road-mapping program will display an on-screen map of the selected location. Several existing road-mapping products typically include the ability to calculate a “best route” between two locations. In other words, the user can input two locations, and the road-mapping program will compute the travel directions from the source location to the destination location. The directions are typically based on distance, travel time, and certain user preferences, such as a speed at which the user likes to drive, or the degree of scenery along the route. Computing the best route between locations may require significant computational time and resources.

The computation of driving directions can be modeled as finding the shortest path on a graph which may represent a road network. Vertices in the graph represent road intersections, and arcs represent road segments. The length of an arc is the cost (e.g., travel time or travel distance) of traversing the corresponding road segment. Given a source s (the origin) and a target t (the destination), the goal is to find the shortest (least costly) path from s to t.

Existing road-mapping programs employ variants of a method attributed to Dijkstra to compute shortest paths. In this sense “shortest” means “least cost” because each road segment is assigned a cost or weight not necessarily directly related to the road segment's length. By varying the way the cost is calculated for each road segment, shortest paths can be generated for the quickest, shortest, or preferred routes.

Dijkstra's algorithm, which is well known, is the standard solution to this problem. It processes vertices one by one, in order of increasing distance from s, until t is reached. In graphs with tens of millions of vertices, as is the case for the road networks of Europe or North America, this cost can be prohibitive. Dijkstra's original method, therefore, is not always efficient in practice, due to the large number of locations and possible paths that are scanned.

Many modern road-mapping programs use heuristic variations of Dijkstra's method, including A* search (a.k.a. heuristic or goal-directed search) in order to “guide” the shortest-path computation in the right general direction. Such heuristic variations typically involve estimating the weights of paths between intermediate locations and the destination. While Dijkstra's algorithm scans the unprocessed vertex v that is closest to s, A* search prefers vertices for which d(v)+π(v) is minimum. Here, d(v) denotes the distance from s to v and π(v) is an estimate on the distance from v to t. Intuitively, A* search scans more promising vertices first. The better the estimate π(v), the fewer vertices will need to be processed to find the path to t.

A widely-used approach to estimating the distance from v to t is to use Euclidean bounds. Given the geographical coordinates of these two points, one can use the straight-line distance between them (the distance “as the crow flies”) as an estimate of the distance one has to drive. The quality of this bound, however, depends heavily on the characteristics of the region being processed. For example, when mountains or large bodies of water are present, a straight line may be a very poor approximation of the shortest path between v and t.

The notion of landmarks is a solution to this problem. The basic idea is to pick a small number k (e.g., k=16) of vertices as landmarks. In a preprocessing stage, one precomputes the graph distances between the landmarks and all the vertices in the graph, then stores them. During queries, this precomputed information can be used to compute lower bounds on any graph distance. Suppose one wants to estimate the distance from v to t, and that neither v nor t is a landmark, but that some other vertex L is. A valid lower bound on dist(v,t) (which is not known) is max{dist(v,L)−dist(t,L), dist(L,t)−dist(L,v)}, which can be precomputed from the preprocessed data. This expression is an immediate application of the triangle inequality to the triangle with v, t, and L as vertices.

Although any landmark L will yield a valid lower bound, the quality of this lower bound (i.e., how close it is to the actual distance) depends on the position of L. For best results, one can compute the expression above for all landmarks L available and take the maximum value observed.

Since one decides which vertices are landmarks before knowing which queries are to be served, it is desirable to pick landmarks so that every possible query is as well covered as possible by at least one landmark. When this is not the case, poor lower bounds will lead to queries that visit too many vertices, which are too slow in practice, lead to increased query times and inefficient use of computing resources.

### SUMMARY

A set of landmarks may be selected during preprocessing by evaluating a sample of the queries that the landmarks may be used in. A cost function may be used to generate a k-median problem. The k-median problem may then be solved with heuristics such as local search. The landmarks may be used with an A* search to find the shortest path from a source to a destination for many queries. The shortest paths may be found for multiple (source, destination) pairs, not only one. The A* search may be unidirectional or bidirectional.

In an implementation, a number of landmarks may be determined for use in processing multiple queries, each consisting of the computation of the shortest path between a start location and a destination location. A large set of landmarks is initially generated relative to the number of landmarks that will subsequently be determined for use in the shortest path computation. Potential queries are selected and a cost for each (landmark, query) pair may be determined. Candidate landmarks, potential queries, and costs may be mapped to a k-median problem, and the k-median problem may be solved for the number of landmarks to use in a shortest path computation, comprising A* search for example, between the start location and the destination location.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an example of a computing environment in which aspects and embodiments may be potentially exploited;

FIG. 2 is an operational flow of an implementation of a method for finding the shortest path between two locations;

FIG. 3 is an operational flow of an implementation of a method for determining a set of landmarks;

FIG. 4 is an operational flow of another implementation of a method for finding the shortest path between two locations; and

FIG. 5 shows an exemplary computing environment.

### DETAILED DESCRIPTION

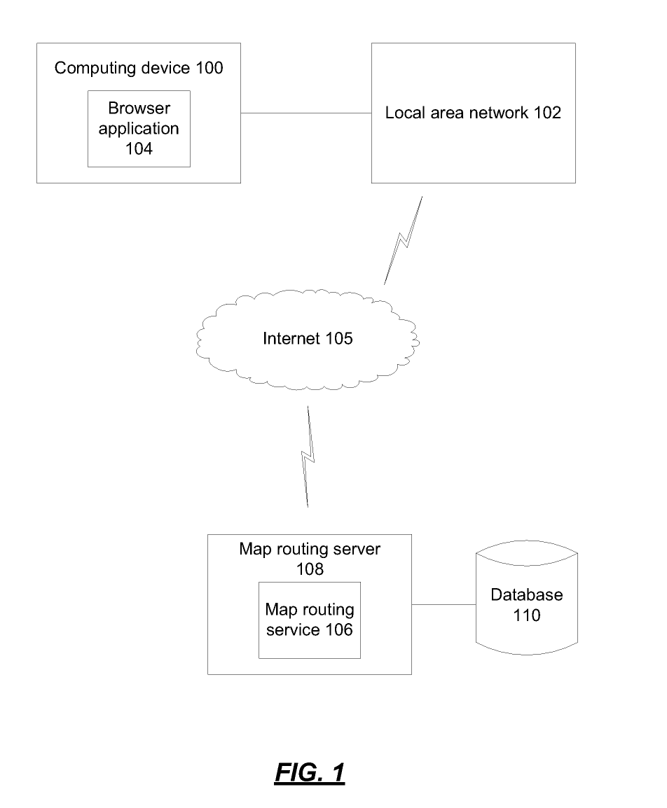

FIG. 1 shows an example of a computing environment in which aspects and embodiments may be potentially exploited. A computing device 100 includes a network interface card (not specifically shown) facilitating communications over a communications medium. The computing device 100 may communicate with a local area network 102 via physical connection. Alternatively, the computing device 100 may communicate with the local area network 102 via wireless wide area network or wireless local area network media, or via other communications media.

The user of the computing device 100, as a result of the supported network medium, is able to access network resources, typically through the use of a browser application 104 running on the computing device 100. The browser application 104 facilitates communication with a remote network over, for example, the Internet 105. One exemplary network resource is a map routing service 106, running on a map routing server 108. The map routing server 108 hosts a database 110 of physical locations and street addresses, along with routing information such as adjacencies, distances, speed limits, and other relationships between the stored locations.

A user of the computing device 100 typically enters start and destination locations as a query request through the browser application 104. The map routing server 108 receives the request and produces an optimal route among the locations stored in the database 110 for reaching the destination location from the start location. The map routing server 108 then sends that optimal route back to the requesting computing device 100. Alternatively, the map routing service 106 is hosted on the computing device 100, and the computing device 100 need not communicate with a local area network 102.

Computing the optimal route, however, is not a trivial task. To visualize and implement routing methods, it is helpful to represent locations and connecting segments as an abstract graph with vertices and directed edges. Vertices correspond to locations, and edges correspond to road segments between locations. The edges may be weighted according to the travel distance, speed limit, and/or other criteria about the corresponding road segment. The general terms “length” and “distance” are used in context to encompass the metric by which an edge's weight or cost is measured. The length or distance of a path is the sum of the weights of the edges contained in the path. For manipulation by computing devices, graphs may be stored in a contiguous block of computer memory as a collection of records, each record representing a single graph node or edge along with associated data.

One approach to computing the optimal route is to use the method of Dijkstra. In general, Dijkstra's method finds the shortest path from a single “source” vertex to all other vertices in the graph by maintaining for each vertex a distance label and a flag indicating if the vertex has yet been scanned. The distance label is initially set to infinity for each vertex, and represents the weight of the shortest path from the source to that vertex using only those vertices that have already been scanned. The method picks an unscanned vertex and relaxes all edges coming out of the vertex (i.e., leading to adjacent vertices). The straightforward implementation of Dijkstra's method chooses for scanning the unscanned vertex with the lowest distance label. To relax an edge (v, w), the method checks if the distance label for w is greater than the sum of the distance label for v and the actual weight of the edge (v, w). If so, the method updates the distance label for w to equal that sum. It can be mathematically shown that once a vertex has been scanned, its distance label does not subsequently change. Some implementations further maintain a parent label for each scanned vertex w, indicating the vertex v whose outgoing edge leads to w on the shortest path. When the method is about to scan a vertex, the path defined by the parent pointers for that vertex is a shortest path.

Although Dijkstra's method can be used to compute shortest paths from a source to all other vertices, it can also be used to find a shortest path from a source to a single destination vertex—the method simply terminates when the destination vertex is about to be scanned. Intuitively, Dijkstra's method searches within a circle, the source vertex in the center, increasing the radius of the circle by choosing vertices and scanning them. If a path is sought for a particular destination, the method terminates with the destination on the boundary of the circle. Searching for a shortest path from vertex s to vertex t via Dijkstra's method results in scanning possible vertices in increasing order of their distance from s. The shortest path to any vertex only passes through vertices that have already been scanned. Once the distance and shortest path to vertex t have been determined, the method stops, leaving those vertices who are further distance than t from s. At this point, in the traditional Dijkstra method, all those vertices who are closer distance than t from s have already been scanned.

Dijkstra's original method is not always efficient in practice to find a shortest path from a source to a particular destination, due to the large number of locations and possible paths that are scanned. Instead, A* search may be used in order to guide the shortest path computation in the right general direction, thereby reducing the number of vertices scanned en route. The A* search operates similarly to the above-described method of Dijkstra, but additionally maintains an estimate for each vertex. The estimate is typically a lower bound on the actual weight of a path from that vertex to the destination. To choose a labeled vertex for scanning, the A* search chooses the unscanned vertex whose sum of labeled distance and estimate is minimal. The rest of Dijkstra's method remains the same. The set of estimates over the vertices form a “potential” function with respect to the destination, and the potential of a vertex is the estimate of the weight of the shortest path from the vertex to the destination.

In order to mathematically guarantee accurate results, heuristic variations may generally use “feasible” estimates (i.e., for an edge from v to w, the estimate for v minus the estimate for w is not more than the actual weight of the edge). The closer these lower bounds are to the actual path weights, the better the estimation. A technique employed by lower bounding implementations uses information implicit in the domain, like Euclidean distances for Euclidean graphs, to compute lower bounds.

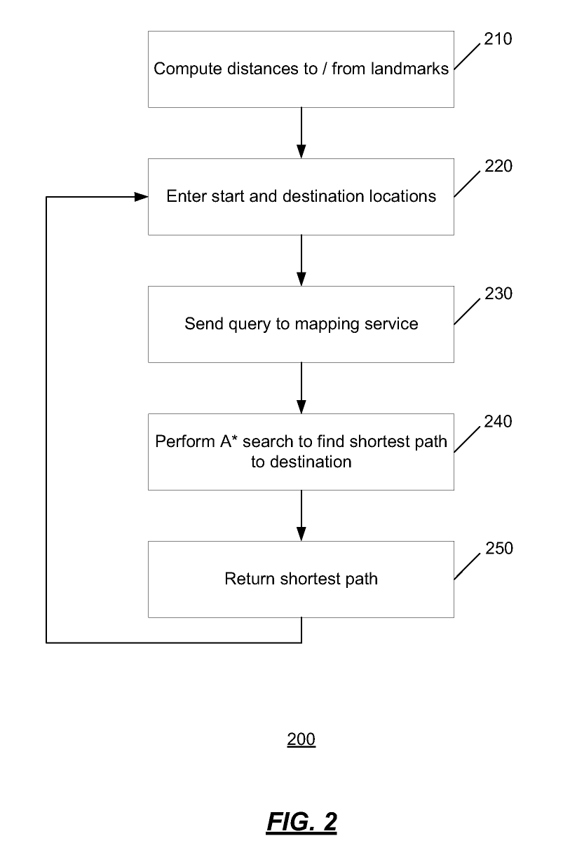

Additional techniques select a small set of “landmarks” and for all vertices precompute distances to and from every landmark. FIG. 2 is an operational flow of an implementation of a method 200 for finding the shortest path between two locations. Actual distances to and from each landmark in the set are computed for each location (i.e., vertex in the corresponding graph) in a preprocessing operation 210. A user enters start and destination locations at operation 220, and the query is sent to a mapping service at operation 230. The mapping service performs an A* search to find the shortest path to the destination from the source at operation 240 using landmarks to compute lower bounds when needed by the search. The mapping service returns the shortest path to the user at operation 250. The user may choose to perform a new query, with processing returning to operation 220, with no need to preprocess again. Although landmarks may be described herein in the context of a unidirectional search, it is contemplated that the landmarks may also be used with respect to a bidirectional search.

Distances to and from landmarks may be used to compute lower bound estimates on distances to the destination. Distances satisfy the “triangle inequality” (i.e., the distance from any vertex u to another vertex w is not greater than the sum of the distances from u to any intermediate vertex v and from v to w), which can be used with the landmarks to produce good lower bounds as follows. Consider a landmark L, then by the triangle inequality, the distance from u to L minus the distance from v to L is not greater than the distance from u to v. Similarly, using distances from L, then the distance from L to v minus the distance from L to u is not greater than the distance from u to v.

As used herein, given a particular query (v,w), a “good” landmark L tends to appear approximately “before” v (i.e., v is close to the shortest path between the landmark and w) or “after” w (i.e., w is close to the shortest path between v and L). Such landmarks tend to give better (higher) lower bounds. Furthermore, preprocessing selects a small number of landmarks, and these are the only ones that may be used for all queries. In particular, there should be a “good” landmark for any possible query (v,w). Thus, landmarks may be spread around the graph (in particular close to the edges of the graph) to try to increase the number of queries (v,w) with “good” landmarks.

Many conventional techniques are used to determine landmarks during preprocessing for lower bounding methods. One known technique is a “random method” in which a fixed number of landmark vertices are selected at random. Another known approach is a “farthest landmark selection method”, which works greedily: a start vertex is chosen and a vertex v1 is found that is farthest away from it. Vertex v1 is added to the set of landmarks. Vertex vi is found as the vertex which is farthest from the current set of landmarks (i.e., the vertex with maximum distance to the closest vertex in the set). Vertex v1 is then added to the set of landmarks. The process repeats until the fixed number of landmarks are found. Another known method for finding landmarks is a “planar landmark selection method.” The planar landmark selection method generally produces landmarks that geometrically lie behind the destination, typically giving bounds for road graphs and other geometric graphs (including non-planar graphs) where graph and geometric distances are strongly correlated.

As described herein, a set of landmarks may be determined for a given graph to improve the average query time. A sample of queries may be simulated and the landmarks may be adjusted to cover the queries as well as possible.

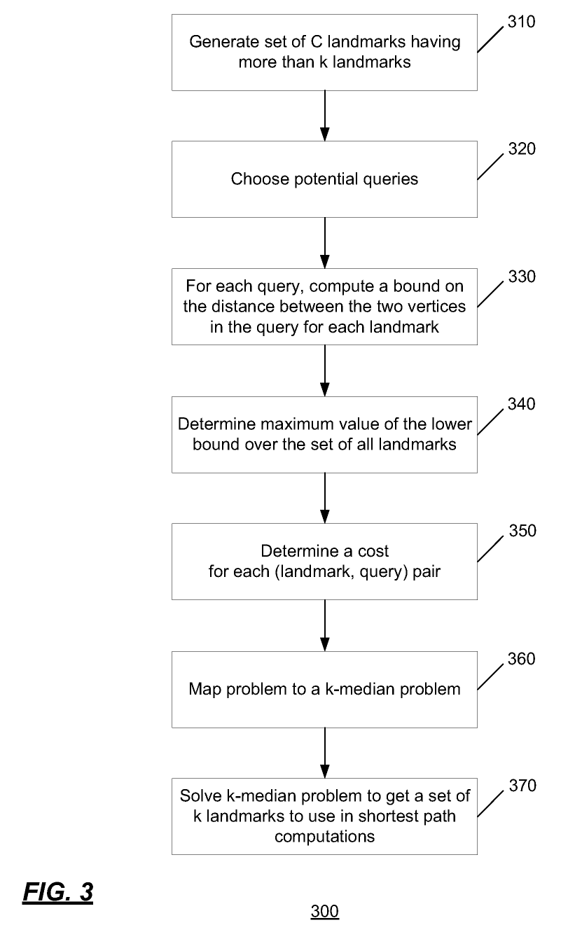

FIG. 3 is an operational flow of an implementation of a method 300 for determining a set of landmarks. The landmarks may accelerate the computation of shortest paths using A* search. As described above, the shortest paths may be used for determining driving directions on road networks. In an implementation of the method 300, a set of k landmarks is found on a graph with n vertices as follows. The number of landmarks k that is sought may be based on a tradeoff between memory size and speed, and may be as large as possible within the memory constraints of the system. As the number of landmarks k increases, the quality of the query results improves.

An existing heuristic may be used to generate a large candidate set of landmarks, then a subset of the landmarks that are good (will likely produce higher quality results based on their costs) are chosen from the candidate set. For example, if 16 landmarks are sought, 128 landmarks may be generated using conventional techniques, and the 16 best landmarks (i.e., the set of 16 landmarks that has the lowest cost) may then be determined as described herein. It is noted that a set of landmarks has a cost, whereas each individual landmark does not have a cost.

A set of landmarks C is generated at operation 310. The set of landmarks C has more than k landmarks. The set of landmarks C may be generated by any known technique. In general, the larger the size of C (denoted by |C|), the higher the quality of the obtained landmarks k will be and the faster the queries will be, but the slower the preprocessing method will be. In an implementation, |C| is chosen to be equal to 8 k, but it is contemplated that |C| may be any value greater than k. Any method may be used to generate the |C| landmarks, but better results may be obtained if the landmarks are spread over the map, in particular along its border (outer edges). For example, one could use a combination of a few landmarks along the border (e.g., 2 k landmarks along the border) and pick the remaining landmarks (6 k, if the total is 8 k) uniformly at random.

A large sample of vertex pairs is used to evaluate the quality of a given set of landmarks. An estimate on the distance between the two vertices on a path is used which is cheap to compute, instead of the actual distance which is expensive.

At operation 320, a large number of potential queries Q may be chosen (e.g., at random). Each query q in the set of potential queries Q consists of a pair (v,w) of vertices in the graph, and represents finding the path from v to w. These queries could be, for example, actual inputs from past users of a shortest path computation system, or they could be chosen uniformly at random. Other selection methods are possible. In general, the larger the number |Q| of queries picked, the slower the preprocessing method is, but the better the results tend to be. In an implementation, |Q| is set equal to cn, where c is a constant and n is the number of vertices in the graph. In an implementation, c may be 0.05 (i.e., five percent of the graph size), for example, for graphs representing the road networks of entire continents, although c may be any number, such as 0.03, 0.10, etc.

At operation 330, for each query, a triangle inequality may be used to compute a bound on the distance between the two vertices in the query. More particularly, for each pair q=(v,w), the triangle inequality may be used to compute the lower bound on the distance from v to w given by each candidate landmark (i.e., use a triangle inequality to compute a bound on the distance from v to w). Defining LB(h,q) as the lower bound given by landmark h, LB(h,q) may be computed as equal to max{dist(h,v)−dist(h,w), dist(v,h)−dist(w,h)}.

At operation 340, the maximum value of the lower bound over the set of all landmarks may be determined. In an implementation, LB(q) may be set to be the maximum value of LB(h,q) over all landmarks h (maximum value of the lower bound over set of all landmarks).

At operation 350, the cost for each (landmark, query) pair may be determined based on a defined cost function. It may be determined by how expensive it would be to use the landmark to deal with the query. If the landmark gives a good lower bound, the cost is low, and low costs are good. In an implementation, for each pair (h,q), where h is a landmark and q is query, cost(h,q) may be defined as a cost function. This function is a nonincreasing function of LB(h,q) (the higher the bound, the lower the cost). High bounds are good as the higher the bound is, the tighter the bound is. In other words, if h1 provides a better (greater) lower bound than h2 for query q, then cost(h1,q)≦cost(h2,q). In an implementation, cost(h,q) may be defined as log(LB(q)−LB(h,q)), where “log” represents the discrete binary logarithm. More precisely, log(x) is defined as zero for x=0 and as the minimum number of bits in the binary representation of x if x>0. In an implementation, cost(h,q) may be set to log(LB(q)−LB(h,q)).

The cost function defined above is small if landmark h provides a relatively good lower bound for query q, and large otherwise. For any subset S of C, the best lower bound for a query q may be obtained by the landmark h in subset S for which cost(h,q) is minimum. In this manner, q is served by h. Among all subsets S of C with exactly k landmarks, the one that minimizes the total cost of all queries should be selected.

At operation 360, the whole problem (i.e., the candidate landmarks, the potential queries, and the costs) may be mapped to the k-median problem. The problem is thus transformed into the k-median problem, which is a well studied clustering problem (i.e., those problems in which the aim is to partition a given set of points into clusters so that the points within a cluster are relatively close with respect to some measure) and a classical problem in combinatorial optimization: given a set of potential facilities (e.g., landmarks), find a subset of size k that minimizes the total cost of serving a given set of users (e.g., queries (the users are queries)), assuming that each user is served by the facility with lowest service cost. This problem is NP-hard, which means there are no known fast algorithms to solve it exactly. There are many known heuristics for solving k-median problems, including local search heuristics.

At operation 370, the k-median problem may be solved using any known heuristic(s) and/or exact method(s) such as integer programming. In an implementation, a local search heuristic may used, although any fast heuristic may be used to solve the k-median problem. With respect to local search, one could, for example, start with k landmarks picked at random and then apply local search to this set (other techniques, such as heuristics or integer programming, could be used). The local search tries to replace one landmark that belongs to the current solution with another that does not, but belongs to the candidate set. It works by computing the profit associated with each of the possible swaps. It discards those whose profit is negative or zero. Among the ones that remain, it picks a swap at random with probability proportional to the profit. The same procedure may then be applied to the new solution. The local search stops when it reaches a local optimum, i.e., a solution on which no improving swap can be made.

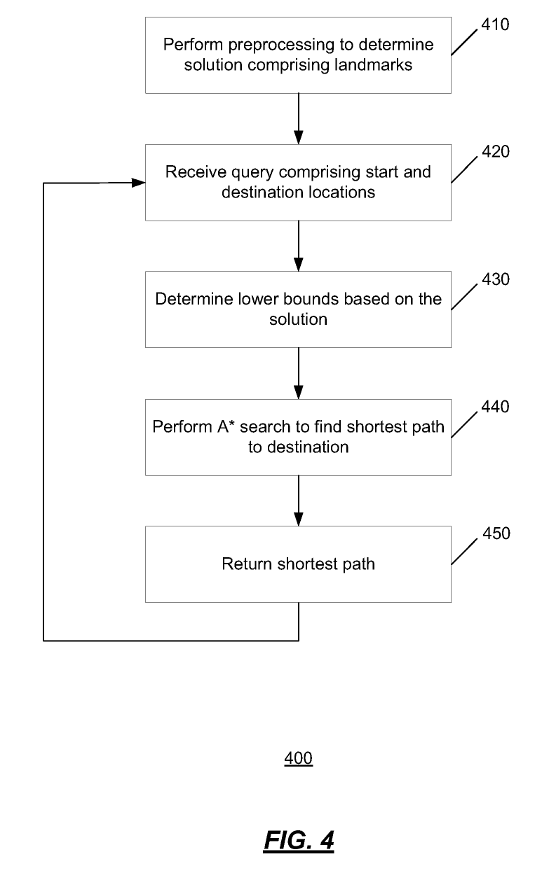

The solution is determined during preprocessing and may be used during processing responsive to a query to determine the shortest path. FIG. 4 is an operational flow of an implementation of a method 400 for finding the shortest path between two locations. At operation 410, preprocessing is performed to determine a solution comprising landmarks, using the method 300 for example. At some point, at operation 420, a query may be received comprising start and destination locations. In an implementation, at operation 430, lower bounds may be determined based on the solution from operation 410. An A* search may be performed based on the lower bounds to determine the shortest path between the start and destination locations, at operation 440. The shortest path may then be returned as a response to the query at operation 450. The user may perform another query, with processing returning to operation 420, with no need to run preprocessing again.

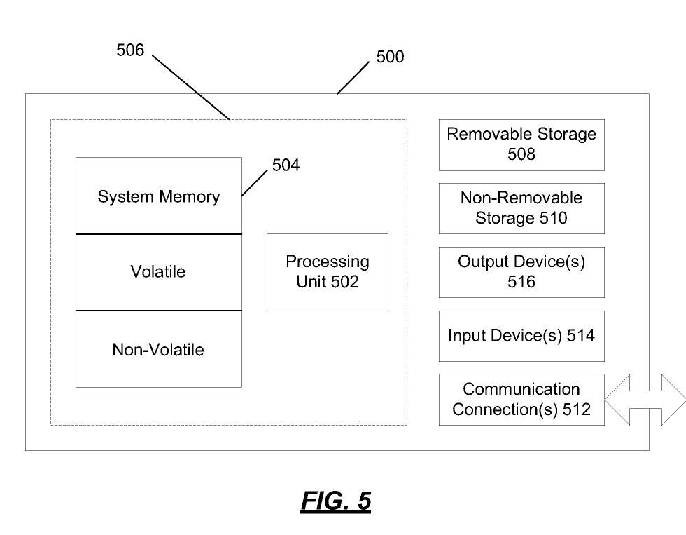

FIG. 5 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 600 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of determining landmarks for use in computing a shortest path between a start location and a destination location, comprising:
generating a plurality of landmarks;
selecting a plurality of potential queries;
determining a cost for each of a plurality of pairs, each pair comprising one of the landmarks and one of the potential queries;
mapping the landmarks, the potential queries, and the costs to a k-median problem; and
solving the k-median problem for a number of landmarks to use in a plurality of shortest path computations.

2. The method of claim 1, wherein solving the k-median problem comprises using a local search.

3. The method of claim 1, wherein the plurality of landmarks comprises about eight times as many landmarks as the number of landmarks resulting from solving the k-median problem.

4. The method of claim 1, wherein generating the plurality of landmarks comprises selecting the plurality of landmarks within a map, a first portion of the plurality of landmarks selected along a plurality of outer edges of the map and the remaining portion of the plurality of landmarks selected uniformly at random within the map.

5. The method of claim 1, wherein each query in the plurality of potential queries comprises a pair of vertices in a graph and represents finding the path between the vertices in the pair.

6. The method of claim 5, further comprising, for each query, using a triangle inequality to compute a bound on a distance between the two vertices in the query.

7. The method of claim 6, wherein the bound is a lower bound, and further comprising determining a maximum value of the lower bound over the plurality of landmarks.

8. The method of claim 6, wherein the costs are based on the bounds.

9. A method of finding a plurality of shortest paths from a start location to a destination location among a set of locations, comprising:
solving a k-median problem to select a plurality of landmarks; and
running a plurality of shortest path computations to determine the shortest paths based on the plurality of landmarks.

10. The method of claim 9, wherein each shortest path computation comprises an A* search, the A* search being unidirectional or bidirectional.

11. The method of claim 10, further comprising computing lower bounds using the plurality of landmarks, the A* search using the lower bounds to determine the shortest path.

12. The method of claim 9, wherein solving the k-median problem comprises using a local search.

13. The method of claim 9, wherein the plurality of landmarks are selected from a set of landmarks, the set of landmarks comprising a greater number of landmarks than the plurality of landmarks.

14. The method of claim 13, wherein the k-median problem is generated pursuant to a plurality of costs determined for each of a plurality of pairs, each pair comprising one of the set of landmarks and one of a plurality of potential queries.

15. The method of claim 9, further comprising receiving a query comprising the start location and the destination location after solving the k-median problem.

16. A computer-readable medium comprising computer-readable instructions for shortest path computation, said computer-readable instructions comprising instructions that:
determine a cost for each of a plurality of pairs, each pair comprising one of a plurality of previously generated landmarks and one of a plurality of potential queries;
map the landmarks, the potential queries, and the costs to a k-median problem; and
solve the k-median problem for a number of landmarks to use in a shortest path computation between a start location and a destination location.

17. The computer-readable medium of claim 16, wherein the instructions that solve the k-median problem comprise instructions that use a local search heuristic.

18. The computer-readable medium of claim 16, further comprising instructions that perform the shortest path computation responsive to a query comprising the start location and the destination location.

19. The computer-readable medium of claim 18, wherein the instructions that perform the shortest path computation comprise instructions that perform an A* search.

20. The computer-readable medium of claim 16, further comprising instructions that:
generate the plurality of previously generated landmarks; and
select the plurality of potential queries.
